(19) United States
(12) Patent Application Publication
(10) Pub. No.: US 2024/0424838 A1
(43) Pub. Date: Dec. 26, 2024

(54) DURABLE TIRES AND RELATED METHODS

(71) Applicant: The Goodyear Tire & Rubber Company, Akron, OH (US)

(72) Inventors: Gilles Reichling, Vichten (LU); Bernd Zotz, Hanau (DE); Philippe Joseph Auguste Muller, Champlon (BE); Nicolas Claude Jean-Claude Froger, Haucourt-Moulaine (FR); Richard Mbewo Samwayera Fosam, Moesdorf (LU); Wojciech Franciszek Baran, Ettelbruck (LU); Patrick Wietor, Palzem (DE)

(21) Appl. No.: 18/426,577

(22) Filed: Jan. 30, 2024

Related U.S. Application Data
(60) Provisional application No. 63/490,373, filed on Mar. 15, 2023.

(51) Int. Cl. B60C 13/00; B60C 1/00; B60C 9/26

(52) U.S. Cl. CPC B60C 13/00; B60C 9/263; B60C 1/0025; B60C 2001/0066; B60C 2009/266; B60C 2013/006; B60C 2013/007

(57) ABSTRACT

A tire may include a bead portion, a carcass, an apex, a belt package, and three gum layers. The carcass may be anchored around the bead core of the bead portion and may comprise a carcass plies portion and a turnup portion. The apex may be located between the carcass plies portion and the turnup portion. The belt package may be arranged between the carcass and a tread. The gum layers may include (a) a sidewall gum layer that extends from a first end located at the apex along the carcass plies to a second end; (b) a wraparound gum layer that wraps around an end of a first inner zigzag belt structure of the belt package; and (c) a belt gum layer that extends from a first end located between the belt package and the carcass plies along the carcass plies to a second end.

### FIELD OF THE INVENTION

The present disclosure relates generally to pneumatic tires and, more particularly, pneumatic tires with improved durability.

### BACKGROUND OF THE INVENTION

A pneumatic tire typically includes a pair of axially separated inextensible beads having at least one carcass ply extending between the two beads. The carcass ply includes axially opposite end portions each of which is turned up around a respective bead and secured thereto. Tread rubber and sidewall rubber are located axially from and radially outward of, respectively, the carcass ply. Additional features may be included in the tires to improve the durability of the tire (the ability for the tire to withstand wear and damage). Examples of these features include a rubber wedge placed between the carcass plies and tread rubber where the sidewall meets the carcass plies or an extended sidewall that extends between the carcass plies and the tread rubber. While both of these features improve the durability of the tire, both also add a significant volume of rubber to the tire, which increases the weight of the tire.

### SUMMARY OF THE INVENTION

A first aspect of the present disclosure is a tire comprising: a bead portion comprising a bead core embedded therein; a carcass anchored around the bead core, the carcass comprising a carcass plies portion and a turnup portion; an apex between the carcass plies portion and the turnup portion; a belt package arranged between the carcass and a tread; a sidewall gum layer that extends from a first end located at the apex along the carcass plies to a second end; a wraparound gum layer that wraps around an end of a first inner zigzag belt structure of the belt package; and a belt gum layer that extends from a first end located between the belt package and the carcass plies along the carcass plies to a second end, wherein a distance between the second end of the belt gum layer and the second end of the sidewall gum layer is 15 mm or greater.

A second aspect of the present disclosure is a tire comprising: a pair of bead portions each containing a bead core embedded therein; a carcass comprising carcass plies that extend between the bead cores with turnup portions of the carcass plies anchored around each bead core; an apex above the bead core and between the carcass plies and the turnup portions; a sidewall portion that extends substantially outward from each of the bead portions in the radial direction; a tread portion that extends between radially outer ends of the sidewall portions; a belt package arranged between the carcass and the tread portion; a sidewall gum layer that extends from a first end located at the apex along the carcass plies to a second end; a wraparound gum layer that wraps around an end of a first inner zigzag belt structure of the belt package; and a belt gum layer that extends from a first end located between the belt package and the carcass plies along the carcass plies to a second end, wherein a distance between the second end of the belt gum layer and the second end of the sidewall gum layer is 15 mm or greater.

### Definitions

The following definitions are applicable to the present invention.

“Apex” means an elastomeric filler located radially above the bead core and between the plies and the turnup ply.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined with respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Chafer” is a narrow strip of material placed around the outside of a tire bead to protect the cord plies from wearing and cutting against the rim and distribute the flexing above the rim.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tread perpendicular to the axial direction.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Elastomer” means a resilient material capable of recovering size and shape after deformation.

“Equatorial plane (EP)” or “Equatorial Centerplane (CP) means the plane perpendicular to the axis of rotation of the tire and passing through the center of the tire tread.

“Flipper” refers to a reinforcing fabric around the bead wire for strength and to tie the bead wire in the tire body.

“Groove” means an elongated void area in a tread that may extend in a circumferential, lateral or angled manner about the tread in a straight, curved, or zigzag configuration. Circumferentially and laterally extending grooves sometimes have common portions. The “groove width” is equal to tread surface area occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves have substantially reduced depth as compared to wide circumferential grooves which interconnect, they are regarded as forming “stiffener elements” tending to maintain a rib-like character in the tread region involved.

“Inner” means toward the inside of the tire.

“Innerliner” means the layer or layers of elastomer or other material that form the inside surface of a tubeless tire and that contain the inflating fluid within the tire.

“Lateral” and “laterally” are used to indicate axial directions across the tread of the tire.

“Lateral edges” means a line tangent to the axially outermost tread contact patch or footprint as measured under normal load and tire inflation, the lines being parallel to the equatorial centerplane.

“Outer” means toward the outside of the tire.

“Ply” means a cord-reinforced layer of rubber-coated, radially deployed or otherwise parallel cords.

“Pneumatic Tire” means a laminated mechanical device of generally toroidal shape (usually an open-torus) having beads and a tread and made of rubber, chemicals, fabric, and steel or other materials. When mounted on the wheel of a motor vehicle, the tire through its tread provides traction and contains the fluid that sustains the vehicle load.

“Radial” and “radially” are used to mean directions radially toward or away from the axis of rotation of the tire.

“Tread” means a molded rubber component which includes that portion of the tire that comes into contact with the road when the tire is normally inflated and under normal load. The tread has a depth conventionally measured from the tread outer surface to the bottom of the deepest groove of the tire.

“Zigzag belt reinforcing structure” means a belt structure formed of at least two layers of cords interwoven together wherein a ribbon of parallel cords having 1 to 20 cords in each ribbon are laid up in an alternating pattern extending at an angle typically between 5 degrees and 45 degrees between lateral edges of the belt, and more preferably between 3 degrees and 11 degrees, and most preferably between 5 degrees and 11 degrees.

### BRIEF DESCRIPTION OF THE DRAWINGS

The invention will be described by way of example and with reference to the accompanying drawings in which:

FIG. 1 illustrates a cross-sectional view of one half of a nonlimiting example tire of the present disclosure;

FIG. 2 is an enlarged view of the area of interest identified in FIG. 1 illustrating a wedge supporting a lateral end portion of a radially innermost belt of the tire, wherein the lateral end portion of the innermost belt is wrapped by a wraparound gum layer;

FIG. 3 is a view similar to FIG. 2 illustrating end portions of the innermost belt and a second belt both wrapped by wraparound gum layers;

FIG. 4 is a view similar to FIG. 2 illustrating end portions of the innermost belt and the second belt without wraparound gum layers, and wherein the end portions are not supported by a wedge;

FIG. 5 is an enlarged view of the area of interest identified in FIG. 1 illustrating a sidewall gum layer extending to a bead filler apex within a bead region of the tire;

FIG. 6 is a view similar to FIG. 5 illustrating the sidewall gum layer extending to an opposite lateral side of the bead filler apex within a bead region;

FIG. 7 is a view similar to FIG. 5 illustrating the sidewall gum layer extending to a bead core within a bead region that does not include a bead filler apex therein; and

FIG. 8 is a view similar to FIG. 5 illustrating the sidewall gum layer extending to point radially outward of bead filler apex within a bead region.

### DESCRIPTION

The present disclosure relates generally to tires and, more particularly, tires with improved durability. The tires of the present disclosure may be used in multiple applications, such as: race tires, passenger tires (including heavy load capacity passenger tires), aircraft tires, agricultural tires, earthmover tires, off-the-road tires, commercial (or truck) tires, and the like.

The tires of the present disclosure include thin layers (e.g., 0.2 mm to 2 mm thick) of extra rubber (referred to herein as gum layers) that are strategically placed to take up and dissipate thermal energy in the tire's sidewall portion during rolling. Advantageously, the gum layers are thin and only in a portion of the tire construction, and, therefore, contribute minimal weight to the overall tire. Further, the rubber composition of the gum layers may have mechanical properties (e.g., a Shore A hardness between 80 and 95) that allow for other durability-improving features (e.g., specific sidewall configurations like sidewall-over-tread and wedges) to be eliminated, which may reduce the complexity of the tire and its manufacturing as well as reduce the weight of the tire while still maintaining a desired level of durability.

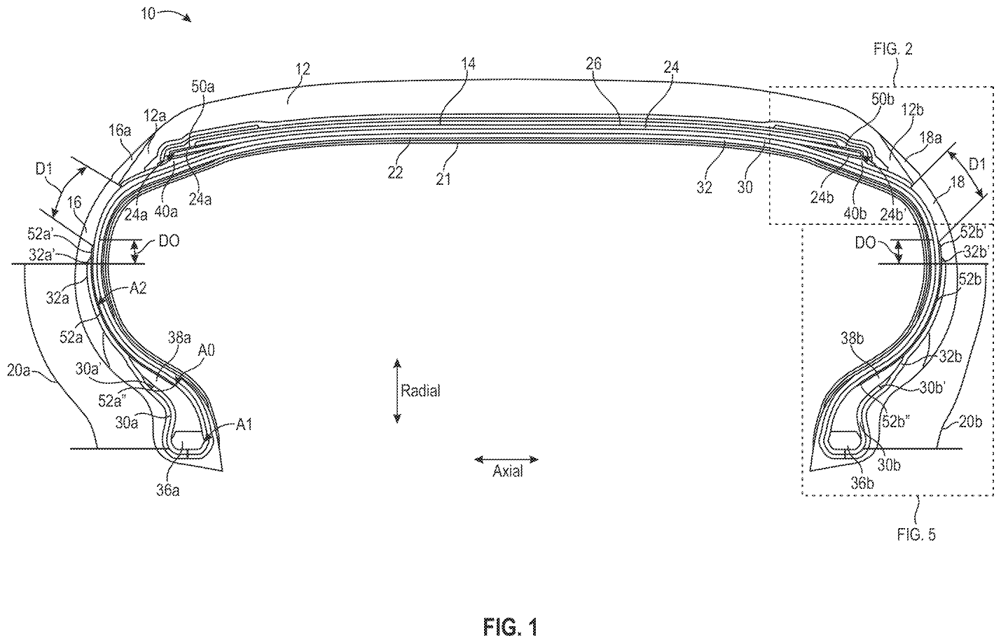

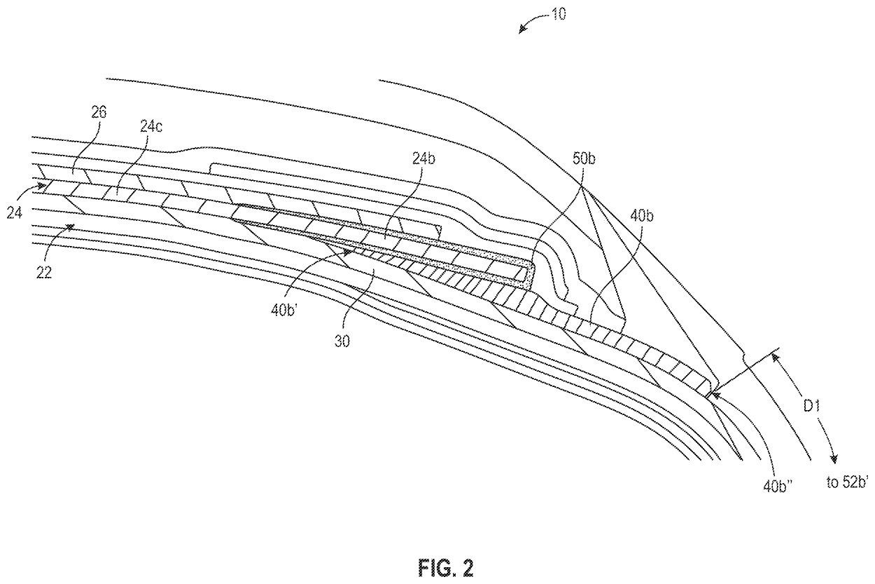

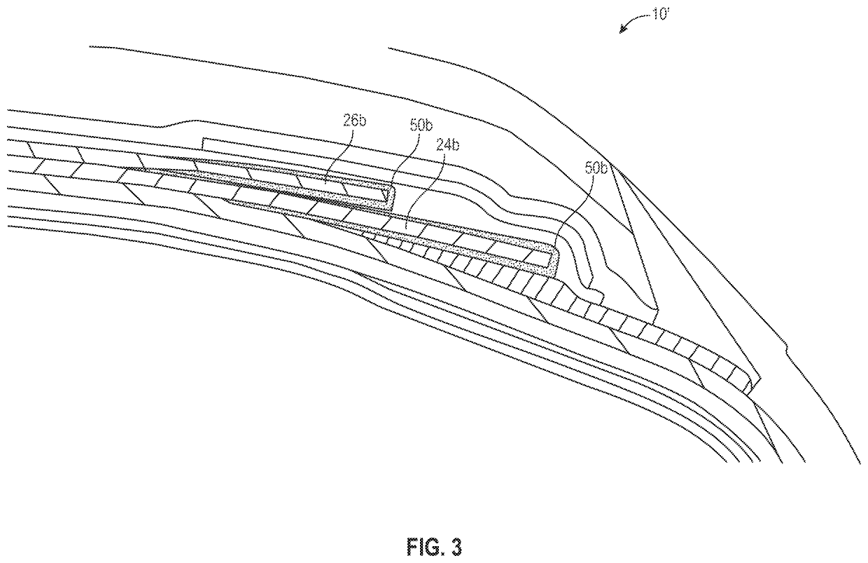

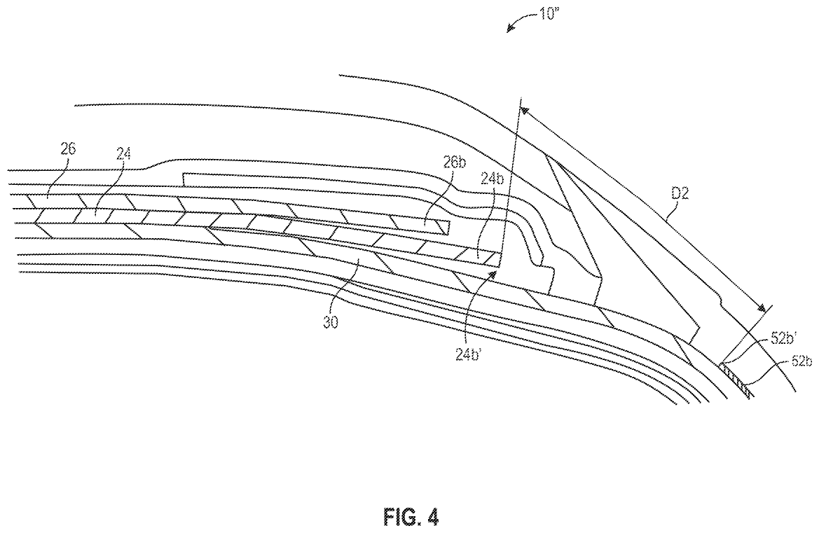

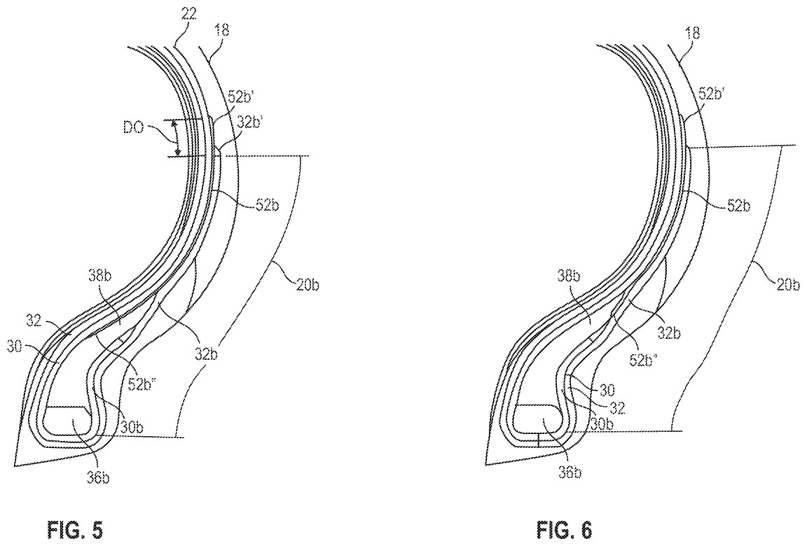

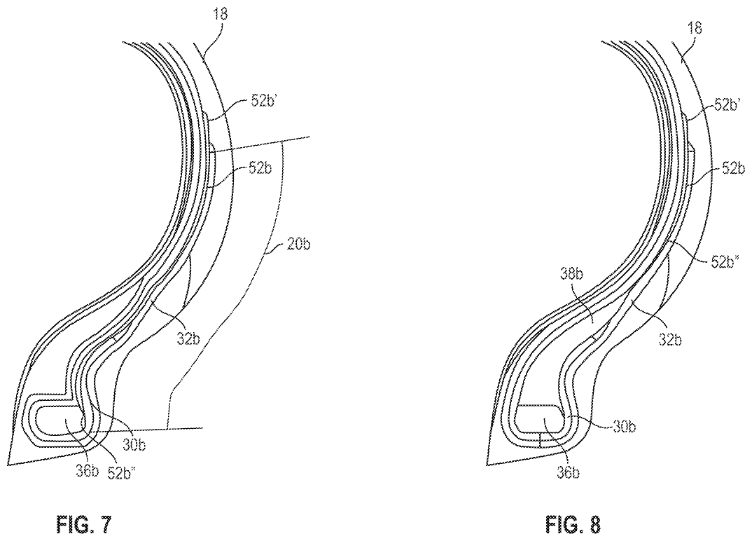

FIG. 1 illustrates a cross-sectional view of a first embodiment of a pneumatic tire 10 according to at least some embodiments of the present disclosure. While the following discussion is illustrated by FIG. 1 showing only half the tire profile, it should be understood that the explanation applies to the other half of the tire 10 as well.

The tire 10 can include a pair of bead portions 23 each containing a bead core 22 embedded therein. Each bead core 22 includes a plurality of metallic filaments. The example tire 10 may be characterized by carcass plies 32 that extend between the bead cores 22 and turnup portions 32a anchored around each bead core 22. Above the bead core 22 between the carcass plies 32 and turnup portions 32a is an apex 34 that comprises an elastomeric filler. The bead portions 23 may further include a chafer, a toeguard, a chipper, and/or a flipper.

The carcass plies 32 are part of a carcass 31 toroidally extending from one of the bead portion 23 to the other bead portion 23. The carcass 31 can be comprised of at least two carcass plies 32 (e.g., two to ten carcass plies). Among these carcass plies 32, inner plies are wound around the bead core 22 from inside of the tire toward outside thereof to form turnup portions 32a. While not illustrated, the carcass may include outer plies that extend downward to the bead core along the outside of the turnup portion of the inner carcass plies. Each of the carcass plies 32 (inner and outer when included) can contain many nylon cords (e.g., nylon-6,6 cords) extending substantially perpendicular to an equatorial plane EP of the tire (i.e., extending in the radial direction R of the tire).

A sidewall portion 24 extends substantially outward from each of the bead portions 23 in the radial direction R of the tire 10.

A tread portion 36 extends between radially outer ends of the sidewall portions 24.

A belt package 40 is arranged between the carcass 31 and the tread portion 36 and is comprised of one or more belt plies 50,52,54,62,64,66. Preferably, the radially innermost belts 50,52,54, which are located near the carcass 31, are low angle belts, with a belt angle of 10 degrees or less, more preferably with a belt angle of 5 degrees or less. The low angle belts 50,52,54 may be formed of belt ply with parallel cords at a desired angle (i.e., belts with cut ends) or may be formed by helically winding a strip of one or more cords about the tire building drum to form a continuous belt with no cut ends. Preferably, the one or more low angle belts 50,52,54 increase in width from the radially innermost belt 50 to the radially outermost belt 54.

Preferably, the radially innermost belts 62,64,66, which are located radially outward of the low angle belts 50,52,54, are zigzag belts structures 62,64,66. Each of the radially outer zigzag belts 62,64,66 are formed by winding a rubberized strip of one or more parallel reinforcement cords generally in the circumferential direction while being inclined to extend between side ends or lateral edges of the layer forming a zigzag path and conducting such a winding many times while the strip is shifted by approximately a width of the strip in the circumferential direction so as not to form a gap between the adjoining strips. As a result, the cords of each strip extend substantially zigzag in the circumferential direction while changing the bending direction at a turnaround point at both ends and are substantially uniformly embedded in the first inner zigzag belt structure 62 over a full region of the first inner zigzag belt 62. The cords of the zigzag belt structures cross with each other at a cord angle of 5 degrees to 40 degrees with respect to the equatorial plane EP of the tire 10 when the strip is reciprocated at least once between both side ends of the ply within every 360 degrees of the circumference as mentioned above.

The radially outermost zigzag belt structure 66 is preferably the narrowest belt, wherein the belt edges extend over the sides of the belt edges of zigzag belt structures 64 and 62. The main belt layers are preferably formed from a hybrid or merged cord of nylon and aramid. More preferably, the main belt cord construction is 3000 d/2 aramid and 1680 d/1 nylon.

The example tire 10 further comprises a barrier layer 37 radially inward of the carcass 31 and an innerliner 38 radially inward of the barrier layer 37 and the carcass 31. The illustrated barrier layer 37 is at a shoulder portion 39 of the tire 10 where, because the tire 10 would be symmetric there is a barrier layer at the inside shoulder portion and the outside shoulder portion. Alternative barrier layer configurations are contemplated including a single barrier layer that extends from the inside shoulder portion and the outside shoulder portion of the tire.

The tire 10 further comprises three gum layers 80,82,84. A sidewall gum layer 80 extends from a first end 80a located at the apex 34 along the carcass plies 32 to a second end 80b. As illustrated, the second end 80b is located between the carcass plies 32 and the sidewall portion 24.

A wraparound gum layer 82 wraps around (or forms a U-shape around) an end 62a of the first inner zigzag belt structure 62. As illustrated, the wraparound gum layer 82 is not in contact with the intermediate zigzag belt structure 64. However, the wraparound gum layer 82 may extend to between the first inner zigzag belt structure 62 and the intermediate zigzag belt structure 64.

A belt gum layer 84 extends from a first end 84a located between belt package 40 and the carcass plies 32 along the carcass plies 32 to a second end 84b. As illustrated, the second end 84b is located between the carcass plies 32 and the tread portion 36. Alternatively, the structure of the tread portion and the sidewall portion may cause the sidewall portion to extend over the belt gum layer rather than the tread portion. Therefore, the second end may alternatively be located between the carcass plies and the sidewall portion.

As illustrated, the belt gum layer 84 is in contact with the wraparound gum layer 82. Alternatively, the most radially outward portion of the sidewall portion may be located between the belt gum layer 84 is and the wraparound gum layer 82.

A distance 86 between the second end 84b of the belt gum layer 84 and the second end 80b of the sidewall gum layer 80 may be 15 mm or greater (e.g., 15 mm to 45 mm, or 15 mm to 30 mm, or 25 mm to 40 mm, or 30 mm to 45 mm).

The gum layers (e.g., gum layers 80,82,84 of FIG. 1) used in the construction of the tires described herein can be formed of a rubber. Preferably, the rubber has a Shore A hardness between 80 and 95, tested according to ASTM S2240-15 (2021).

Examples of rubbers suitable for use in the gum layers described herein may include, but are not limited to, neoprene (polychloroprene), polybutadiene (including cis-1,4-polybutadiene), polyisoprene (including cis-1,4-polyisoprene) (natural or synthetic), butyl rubber, halobutyl rubber (including chlorobutyl rubber or bromobutyl rubber), styrene/isoprene/butadiene rubber, copolymers of 1,3-butadiene or isoprene with monomers such as styrene, acrylonitrile and methyl methacrylate, ethylene/propylene terpolymers (also known as ethylene/propylene/diene monomer (EPDM) terpolymers (e.g., ethylene/propylene/dicyclopentadiene terpolymers)), alkoxy-silyl end functionalized solution polymerized polymers, styrene-butadiene rubber, polybutadiene rubber, isoprene butadiene rubber, styrene isoprene butadiene rubber, the like, and any combination thereof. Each gum layer may have the same or a different composition.

The rubber of the gum layers may also include conventional rubber compounding ingredients including processing oil, accelerators, conventional sulfur curing agents, pigments, carbon black, zinc oxide, stearic acid, tackifying resin, plasticizer, the like, and any combination thereof.

The gum layers may have a thickness of 0.2 mm to 2 mm (or 0.2 mm to 1 mm, or 0.5 mm to 1.5 mm, or 1 mm to 2 mm). Each gum layer may have the same or a different thickness from each other.

The rubber of the barrier layer, innerliner, carcasses (including the carcass plies), belt packages, and tread portions described herein may comprise a rubber. Specific examples of suitable rubbers may include, but are not limited to, neoprene (polychloroprene), polybutadiene (including cis-1,4-polybutadiene), polyisoprene (including cis-1,4-polyisoprenc) (natural or synthetic), butyl rubber, halobutyl rubber (including chlorobutyl rubber or bromobutyl rubber), styrene/isoprene/butadiene rubber, copolymers of 1,3-butadiene or isoprene with monomers such as styrene, acrylonitrile and methyl methacrylate, ethylene/propylene terpolymers (also known as ethylene/propylene/diene monomer (EPDM) terpolymers (e.g., ethylene/propylene/dicyclopentadiene terpolymers)), alkoxy-silyl end functionalized solution polymerized polymers, styrene-butadiene rubber, polybutadiene rubber, isoprene butadiene rubber, styrene isoprene butadiene rubber, the like, and any combination thereof. The foregoing rubbers may also include conventional rubber compounding ingredients including, but not limited to, processing oil, accelerators, conventional sulfur curing agents, pigments, carbon black, zinc oxide, stearic acid, tackifying resin, plasticizer, the like, and any combination thereof.

The production of the tires of the present disclosure may include assembling the tire components followed by curing according to production methods conventionally known in the art, which may be dependent on the type of tire. For example, passenger tires may be cured at a temperature ranging from about 130° C. to about 170° C., and truck tires may be cured at a temperature ranging from about 150° C. to about 180° C.

Gum layers typically come in a roll (e.g., 1 cm to 20 cm wide). When assembling the components of the tires of the present disclosure the gum layers may be applied in a side-by-side configuration with the length of the gum layer extending along the cross-section of the tire as illustrated in FIG. 1.

### EXAMPLE EMBODIMENTS

Embodiment 1. A tire comprising: a bead portion comprising a bead core embedded therein; a carcass anchored around the bead core, the carcass comprising a carcass plies portion and a turnup portion; an apex between the carcass plies portion and the turnup portion; a belt package arranged between the carcass and a tread; a sidewall gum layer that extends from a first end located at the apex along the carcass plies to a second end; a wraparound gum layer that wraps around an end of a first inner zigzag belt structure of the belt package; and a belt gum layer that extends from a first end located between the belt package and the carcass plies along the carcass plies to a second end, wherein a distance between the second end of the belt gum layer and the second end of the sidewall gum layer is 15 mm or greater.

Embodiment 2. The tire of Embodiment 1, wherein the belt gum layer contacts the wraparound gum layer.

Embodiment 3. The tire of any preceding Embodiment, further comprising a sidewall portion extending outward from the bead portion in a radial direction and between the sidewall gum layer and the wraparound gum layer.

Embodiment 4. The tire of Embodiment 3, wherein a portion of the sidewall portion is located between a portion of the belt gum layer and a portion of the wraparound gum layer.

Embodiment 5. The tire of any preceding Embodiment, wherein the sidewall gum layer has a thickness of 0.2 mm to 2 mm.

Embodiment 6. The tire of any preceding Embodiment, wherein the sidewall gum layer comprises a rubber having a Shore A hardness between 80 and 95.

Embodiment 7. The tire of any preceding Embodiment, wherein the sidewall gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

Embodiment 8. The tire of any preceding Embodiment, wherein the wraparound gum layer has a thickness of 0.2 mm to 2 mm.

Embodiment 9. The tire of any preceding Embodiment, wherein the wraparound gum layer comprises a rubber having a Shore A hardness between 80 and 95.

Embodiment 10. The tire of any preceding Embodiment, wherein the wraparound gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

Embodiment 11. The tire of any preceding Embodiment, wherein the belt gum layer has a thickness of 0.2 mm to 2 mm.

Embodiment 12. The tire of any preceding Embodiment, wherein the belt gum layer comprises a rubber having a Shore A hardness between 80 and 95.

Embodiment 13. The tire of any preceding Embodiment, wherein the belt gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

Embodiment 14. A tire comprising: a pair of bead portions each containing a bead core embedded therein; a carcass comprising carcass plies that extend between the bead cores with turnup portions of the carcass plies anchored around each bead core; an apex above the bead core and between the carcass plies and the turnup portions; a sidewall portion that extends substantially outward from each of the bead portions in the radial direction; a tread portion that extends between radially outer ends of the sidewall portions; a belt package arranged between the carcass and the tread portion; a sidewall gum layer that extends from a first end located at the apex along the carcass plies to a second end; a wraparound gum layer that wraps around an end of a first inner zigzag belt structure of the belt package; and a belt gum layer that extends from a first end located between the belt package and the carcass plies along the carcass plies to a second end, wherein a distance between the second end of the belt gum layer and the second end of the sidewall gum layer is 15 mm or greater.

Embodiment 15. The tire of Embodiment 14, where the distance is 15 mm to 45 mm.

Embodiment 16. The tire of one of Embodiments 14-15, wherein at least two of: the sidewall gum layer, the wraparound gum layer, and the belt gum layer have a different composition.

Embodiment 17. The tire of one of Embodiments 14-16, wherein at least two of: the sidewall gum layer, the wraparound gum layer, and the belt gum layer have a different thickness.

Embodiment 18. The tire of one of Embodiments 14-17, wherein at least one of: the sidewall gum layer, the wraparound gum layer, and the belt gum layer comprise a rubber having a Shore A hardness between 80 and 95.

Embodiment 19. The tire of one of Embodiments 14-18, wherein at least two of: the sidewall gum layer, the wraparound gum layer, and the belt gum layer have a thickness of 0.2 mm to 2 mm.

Embodiment 20. The tire of one of Embodiments 14-19, wherein the tire is a race tire, a passenger tire, a heavy load capacity passenger tire, an aircraft tire, an agricultural tire, an earthmover tire, an off-the-road tire, or a commercial tire.

To facilitate a better understanding of the embodiments of the present invention, the following examples of preferred or representative embodiments are given. In no way should the following examples be read to limit, or to define, the scope of the invention.

### Examples

Gum layers of 0.5 mm to 0.6 mm thickness were used in the construction of four different vehicle tire configurations, each similar to the FIG. 1. Under high-load testing, the durability of the tire was improved with only a minor increase (about 1% to 2%) in rolling resistance as compared to said configurations without the gum layers.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present invention are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising:
a bead portion comprising a bead core embedded therein;
a carcass anchored around the bead core, the carcass comprising a carcass plies portion and a turnup portion;
an apex between the carcass plies portion and the turnup portion;
a belt package arranged between the carcass and a tread;
a sidewall gum layer that extends from a first end located at the apex along the carcass plies to a second end;
a wraparound gum layer that wraps around an end of a first inner zigzag belt structure of the belt package; and
a belt gum layer that extends from a first end located between the belt package and the carcass plies along the carcass plies to a second end, wherein a distance between the second end of the belt gum layer and the second end of the sidewall gum layer is 15 mm or greater.

2. The tire of claim 1, wherein the belt gum layer contacts the wraparound gum layer.

3. The tire of claim 1, further comprising a sidewall portion extending outward from the bead portion in a radial direction and between the sidewall gum layer and the wraparound gum layer.

4. The tire of claim 3, wherein a portion of the sidewall portion is located between a portion of the belt gum layer and a portion of the wraparound gum layer.

5. The tire of claim 1, wherein the sidewall gum layer has a thickness of 0.2 mm to 2 mm.

6. The tire of claim 1, wherein the sidewall gum layer comprises a rubber having a Shore A hardness between 80 and 95.

7. The tire of claim 1, wherein the sidewall gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

8. The tire of claim 1, wherein the wraparound gum layer has a thickness of 0.2 mm to 2 mm.

9. The tire of claim 1, wherein the wraparound gum layer comprises a rubber having a Shore A hardness between 80 and 95.

10. The tire of claim 1, wherein the wraparound gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

11. The tire of claim 1, wherein the belt gum layer has a thickness of 0.2 mm to 2 mm.

12. The tire of claim 1, wherein the belt gum layer comprises a rubber having a Shore A hardness between 80 and 95.

13. The tire of claim 1, wherein the belt gum layer comprises a rubber selected from the group consisting of: neoprene, polybutadiene, polyisoprene, butyl rubber, halobutyl rubber, styrene/isoprene/butadiene rubber, copolymers of 1,3-butadiene or isoprene with monomers such as styrene, acrylonitrile and methyl methacrylate, ethylene/propylene terpolymers, alkoxy-silyl end functionalized solution polymerized polymers, styrene-butadiene rubber, polybutadiene rubber, isoprene butadiene rubber, styrene isoprene butadiene rubber, and any combination thereof.

14. A tire comprising:
a pair of bead portions each containing a bead core embedded therein;
a carcass comprising carcass plies that extend between the bead cores 22 with turnup portions of the carcass plies anchored around each bead core;
an apex above the bead core and between the carcass plies and the turnup portions;
a sidewall portion that extends substantially outward from each of the bead portions in the radial direction;
a tread portion that extends between radially outer ends of the sidewall portions;
a belt package arranged between the carcass and the tread portion;
a sidewall gum layer that extends from a first end located at the apex along the carcass plies to a second end;
a wraparound gum layer that wraps around an end of a first inner zigzag belt structure of the belt package; and
a belt gum layer that extends from a first end located between the belt package and the carcass plies along the carcass plies to a second end, wherein a distance between the second end of the belt gum layer and the second end of the sidewall gum layer is 15 mm or greater.

15. The tire of claim 14, where the distance is 15 mm to 45 mm.

16. The tire of claim 14, wherein at least two of: the sidewall gum layer, the wraparound gum layer, and the belt gum layer have a different composition.

17. The tire of claim 14, wherein at least two of: the sidewall gum layer, the wraparound gum layer, and the belt gum layer have a different thickness.

18. The tire of claim 14, wherein at least one of: the sidewall gum layer, the wraparound gum layer, and the belt gum layer comprise a rubber having a Shore A hardness between 80 and 95.

19. The tire of claim 14, wherein at least two of: the sidewall gum layer, the wraparound gum layer, and the belt gum layer have a thickness of 0.2 mm to 2 mm.

20. The tire of claim 14, wherein the tire is a race tire, a passenger tire, a heavy load capacity passenger tire, an aircraft tire, an agricultural tire, an earthmover tire, an off-the-road tire, or a commercial tire.

21. A pneumatic tire comprising:
a tread;
a carcass ply;
a belt interposed between the carcass ply and the tread, the belt having opposed first and second lateral edges;
a pair of sidewall portions,
a pair of bead regions each including an annular bead core, and
a pair of sidewall gum layers, wherein each sidewall gum layer has a first end and a second end, wherein the second end is located within a second bead region of the pair of bead regions.

22. The pneumatic tire of claim 21 wherein the first end is located axially inward of the belt lateral edge.

23. The pneumatic tire of claim 21 wherein the first end is located in the sidewall portion between a shoulder and a turnup of the carcass ply.

24. The pneumatic tire of claim 21 wherein the first end is located in the sidewall portion between a shoulder and the bead region.

25. The tire of claim 21, further comprising a pair of wedges, wherein a first end of each wedge is disposed between the first belt and the ply.

26. The tire of claim 25 wherein an outer end of each wedge is disposed radially between and in contact with one of the lateral end portions of the tread cap and the radially outermost ply.

27. The tire of claim 21, further comprising a pair of wraparound gum layers, wherein a first wraparound gum layer wraps around a first lateral end portion of the first belt, and wherein a second wraparound gum layer wraps around a second lateral end portion of the first belt, and wherein the inner ends of each wedge are in contact with a corresponding wedge.

28. The tire of claim 21, wherein the first end of each of the sidewall gum layers is in contact with the radially outermost ply and a corresponding wedge.

29. The tire of claim 21, wherein each of the bead regions includes an bead filler apex therein disposed radially outward of the annular bead core therein, and wherein the second end of each sidewall gum layer is in contact with a corresponding bead filler apex.

30. The tire of claim 21, wherein each of the sidewall gum layers has a length in a range of 50 mm to 90 mm.

31. The tire of claim 21, wherein each of the sidewall gum layers comprise a rubber and/or an elastomer having a Shore A hardness between 80 and 95 and a RPA G' 1 percent of 4 MPa or greater.

32. The tire of claim 21, wherein radially outermost portions of each sidewall overlie lateral end portions of the tread cap.
